(19) United States
(12) Patent Application Publication
(10) Pub. No.: US 2024/0288830 A1
(43) Pub. Date: Aug. 29, 2024

(54) MODULAR INSTALLATION FOR THE ASSEMBLY AND REPAIR OF CLOCKWORKS

(71) Applicant: Peter T. Gschwind, Murten (CH)

(72) Inventor: Peter T. Gschwind, Murten (CH)

(21) Appl. No.: 18/588,697

(22) Filed: Feb. 27, 2024

(30) Foreign Application Priority Data
Feb. 28, 2023 (EP) 23159228.8

(51) Int. Cl. G04D 1/00; G04D 3/00; G04D 5/00

(52) U.S. Cl. CPC G04D 1/0057; G04D 3/0012; G04D 3/0028; G04D 3/0038; G04D 5/00

(57) ABSTRACT

A modular installation for assembly and repair that includes an adaptable number of assembly workstations, preferably at least one regulating station, a central oil station and a transport system for the transport of clockworks in disassembled or partially disassembled condition between the stations. By dividing the work steps into relatively simple assembly and the more demanding ones of oiling and regulating and by connecting the corresponding stations with a transport system as well as, at the assembly stations, a combination of two transport systems for controlled placement of the components of a particular clockwork movement and the associated transport components at an assembly station, a parallel but error-free and faster repair of clockworks is achieved. Preferably, the oil station is highly automated to carry out the oiling processes reproducibly and quickly. With the use of a manipulation ring, clockworks of different dimensions with standardized tools may be handled.

The present invention is based on a modular installation according to the generic term of claim 1.

In the clockmaking industry, the automation of the labor-intensive assembly of clockworks to increase productivity has been an important objective for over 50 years. Numerous efforts have been undertaken to automate the working steps in the assembly, especially of quartz-clockworks and newly also of mechanical clockworks. These developments have so far not transferred to the servicing of clocks, because in the servicing of clocks every clock is different and because each clock must be reassembled with its original components after a repair or remedial maintenance, and the assembly process thus differs significantly from serial production.

Today, assembly lines are the state of the art, which execute different steps of assembly, quality control and, on different stations, certain lubricating and oiling processes supported by assembly personnel, for individual clockworks in serial production. These lines are however always limited to a specific group of structurally identical clockwork models. Every switch to a different clockwork model is difficult and always very time consuming for the exchange and set up of tools. Consequently, work in the servicing of clocks is still largely done in the traditional way to this day. Staff productivity can be doubled, occasionally tripled, at most, by sequential assembly.

Assembly lines for serial production are not suited for usage in the servicing of clocks, because the assembly processes are much more complex here. After the disassembly all components of the clock, other than the components that need to be exchanged, must be built into the same clock again. Sequential assembly still remains labor intensive and partially dependent on trained professionals.

Sequential assembly alone is thus not expedient, due to the rapidly increasing amounts and simultaneous shortage of experts.

Oiling presents another problem: The oiling of the clockwork is a challenging working step, which is usually executed directly during the repair, by a clockmaker who is familiar with the different clockworks. Only one or two clockworks daily are processed by a clockmaker. In the sequential assembly the oiling is split and executed by different professionals depending on the designated process, which does however not lead to an increase in capacity, and partially limited to one professional, which leads to a low increase in capacity.

It is an object of the present invention to increase the number of processed clockworks per person significantly.

Another object consists in reducing the demand of specialist staff.

Such an assembly line, or modular installation, which at least solves the first named task, is given in claim 1. The additional claims offer preferred embodiments of the assembly line.

Therefore, a novel installation is needed which identifies which clockwork lies at the workspace respectively, and provides the matching components at the same time, so that a semiskilled assembly worker can execute the sequential steps of the assembly. Solutions are shown for those working steps, which make it possible to transport the clockwork to an automatic oiling station and back to the assembly work station after every phase of assembly.

This wholly novelly conceptualized oiling station should preferably be able to serve all oil points, including such oil points in which the components are conventionally held in one of the clockmaker hands with a special tool and oiled with the other hand.

Further preferably present features of such an installation are as follows:
The oiling station should automatically match its program of the oil points to the clockwork.
After a series of assembly and oiling steps the clockwork should be forwarded to a regulating station, pre-checked and its function measured and adjusted in different testing situations. Afterward, the clockwork should be transported back to the respective assembly stations, where the further assembly steps are executed to completion, with repeated intermittent oiling.

The invention will be further explained using an exemplary embodiment with reference to the Figures. They show:

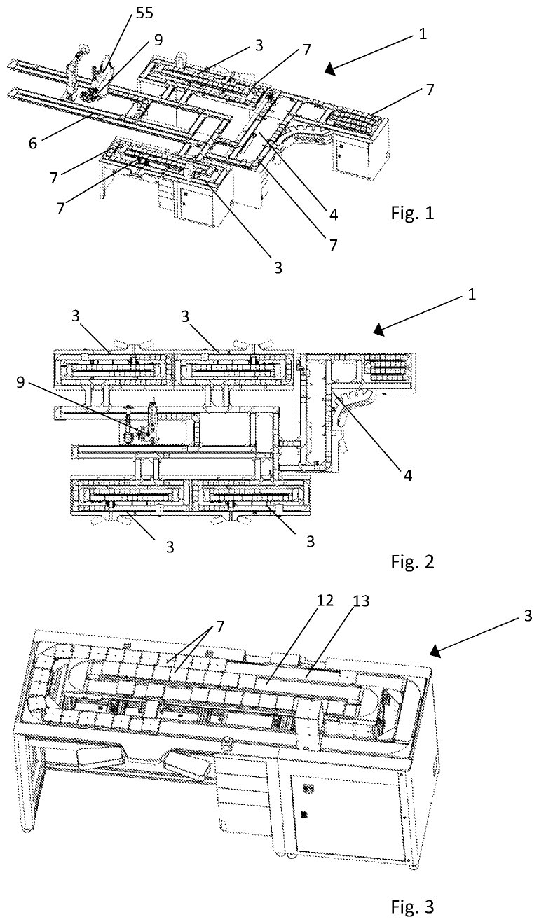

FIG. 1 Perspective view of a modular installation with two assembly stations;

FIG. 2 plan view of a modular installation with four assembly stations;

FIG. 3 Enlarged partial view from FIG. 1: view of an assembly station;

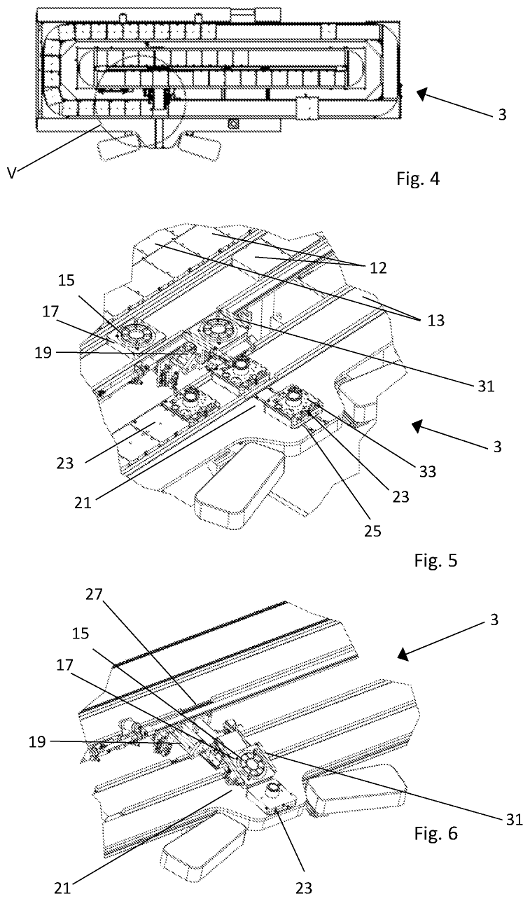

FIG. 4 Plan view of an assembly station according to FIG. 3

FIG. 5 Enlarged partial view according to V in FIG. 4, perspective view;

FIG. 6 Perspective view of a cleaning basket (a “basket”);

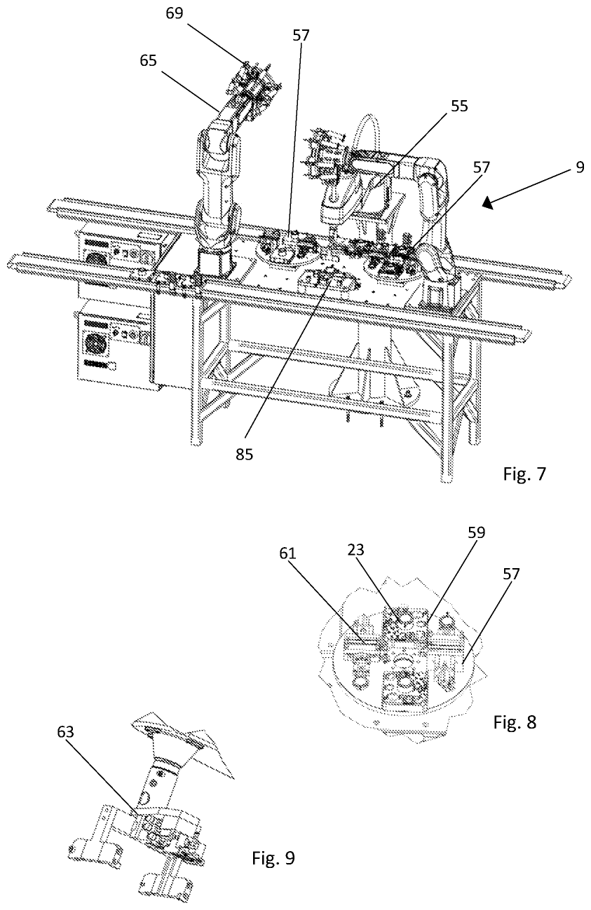

FIG. 7 Perspective view of an oiling station;

FIG. 8 Enlarged view of the rotary plate from FIG. 7;

FIG. 9 Head of the handling unit in FIG. 8;

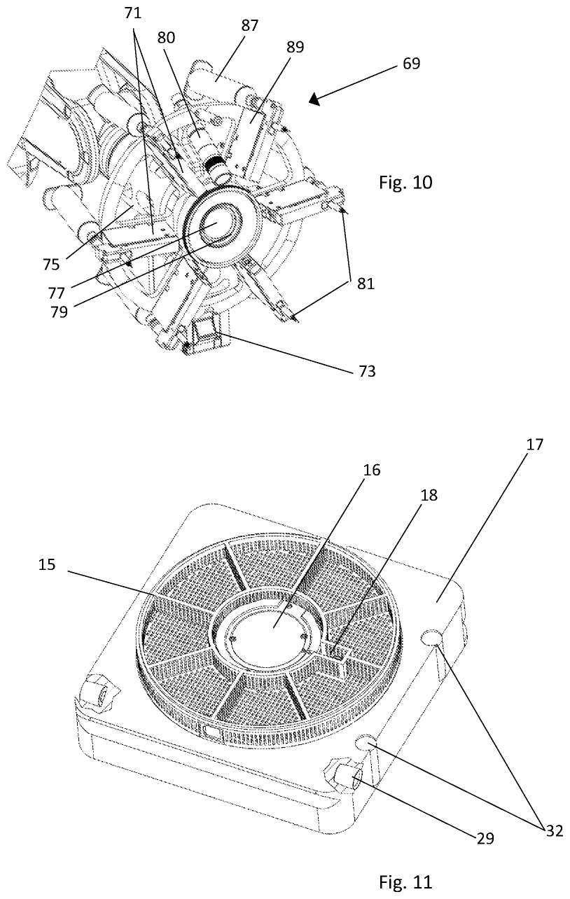

FIG. 10 Head of the oiling robot;

FIG. 11 Basket carrier with cleaning basket, perspective depiction;

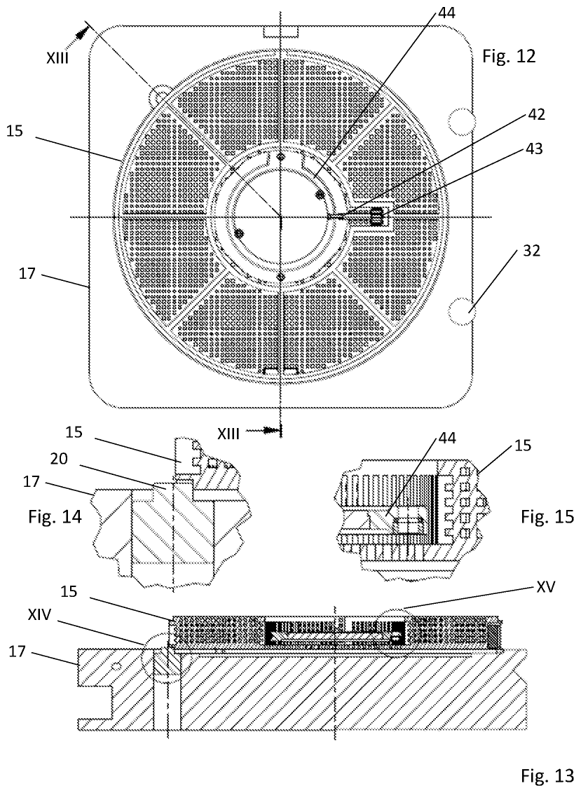

FIG. 12 Plan view of the basket carrier according to FIG. 11;

FIG. 13 Section according to XIII-XIII in FIG. 12;

FIG. 14 Enlarged partial section according to XIV in FIG. 13;

FIG. 15 Enlarged partial section according to XV in FIG. 13;

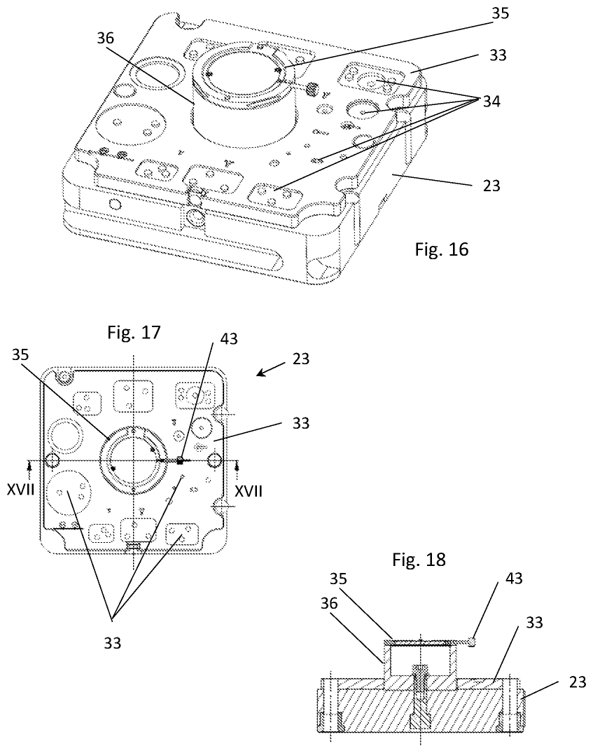

FIG. 16 Perspective view of a workpiece carrier;

FIG. 17 Plan view of the workpiece carrier according to FIG. 16;

FIG. 18 Section according to XVIII-XVIII in FIG. 17;

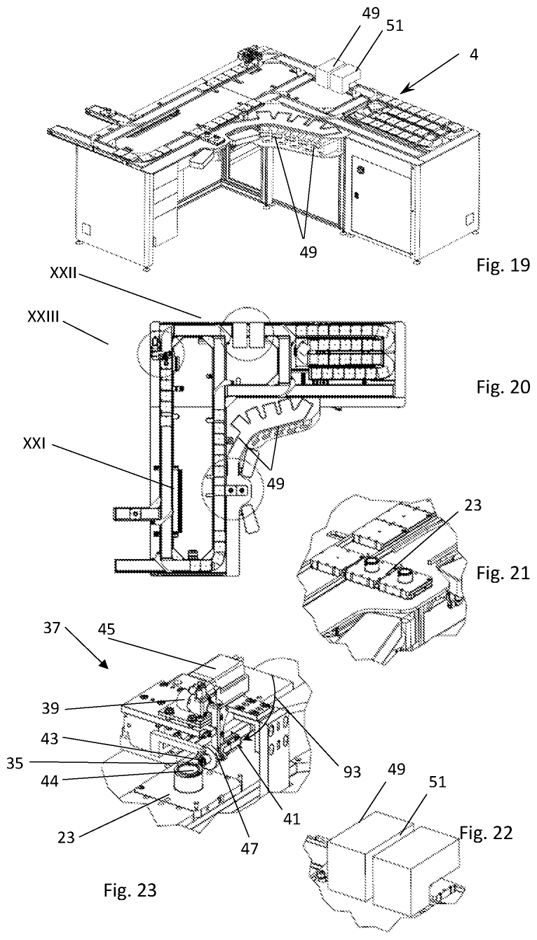

FIG. 19 Perspective view of a regulating station;

FIG. 20 Plan view of the regulating station according to FIG. 19;

FIG. 21 Enlarged section of the regulating station according to XXI in FIG. 20;

FIG. 22 Enlarged section of the visual inspection unit according to XXII in FIG. 20;

FIG. 23 Enlarged section of the of the winding unit according to XXIII in FIG. 20;

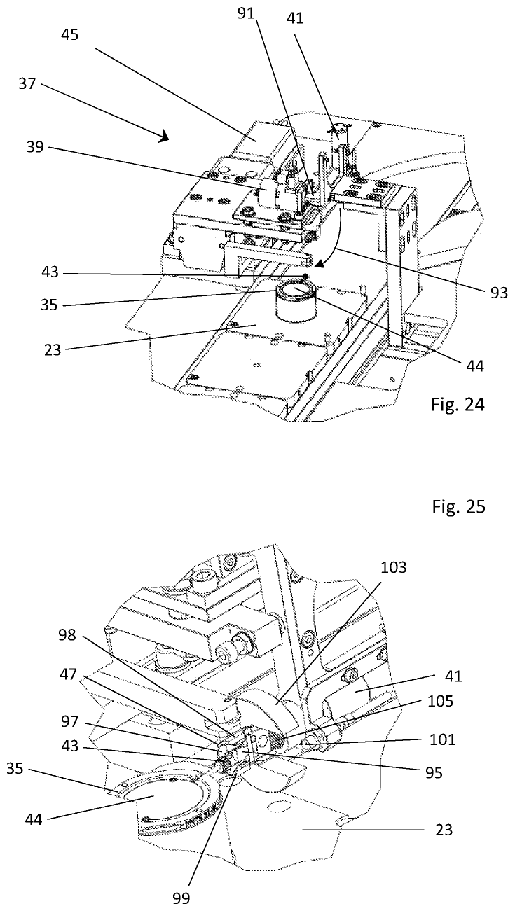

FIG. 24 View of the winding unit in resting position; and

FIG. 25 Enlarged view of the winding unit with partial section of the winding pliers.

The modular installation 1, which can be modularly enhanced, comprises in FIG. 1 as an example three work stations, namely two assembly stations 3 and one regulating station 4, a central conveyor system 6, local conveyor systems 7 in connection with the central conveyor system 6, among others at the work stations (here: assembly stations 3, regulating station 4), as well as an automatic oiling unit 9 for oiling the clockworks and for the handling connected to it. The installation 1 can be supplemented with additional assembly stations 3 or regulating stations 4. FIG. 2 for example shows an installation with four assembly stations 3. Other enhancement steps are also conceivable however, in extreme cases only one assembly station or three, five, six etc. assembly stations. The number of oil units 9 for example is also customizable in compliance with the modular concept.

Every station has its own switchbox for controlling, which allows for the continued operation of the other stations in case of malfunction. The central control undertakes the transport to and from the different stations, and-if there are issues with a clockwork during the automatic checks, which must be resolved by a specialist-to a special interim storage.

Every assembly station 3 consists of one upper and one lower conveyor belt. On the upper conveyor belt 12 a number (e.g. twenty or more) cleaning baskets or baskets 15 are moved on individual basket carriers 17. Each basked is supplied with an RFID. An RFID (“Radio Frequency IDentification”) is a tag or a marking, which can be read by an electromagnetic high frequency signal. As a rule, the reading signal also serves as an energy source, so that an RFID does not need its own energy source.

In each of the baskets 15 there are the individual disassembled and cleaned components of the clockwork of a defined repair order which is distinctly marked with an RFID. During the loading of the baskets 15 onto the upper conveyor belt 12 the RFIDs are automatically read. The upper conveyor belt 12 includes an RFID-reader (not depicted) which transmits the position to the central control before and after the positioning unit for the assembly respectively. RFIDs and RFID-readers are known as such and thus not explained in detail. An RFID can especially also be built so small, that it would only be visible in a figure with significant enlargement. It could for example be clamped onto the cleaning basket 15 (a “basket”) or attached in a different manner, or be integrated into the body of the baskets 15. Notable about the basket 15 is the centrally arranged compartment 16, into which the clockwork is deposited. It distinguishes itself with a protrusion 18 for an actuating shaft (“tige”) 42 with crown 43 of a clockwork, of which only the work plate 44 is depicted here, as the clockwork, disassembled into its components, is lying in the basket 15.

A peg 20 determines a twist-proof attaching of the cleaning basket 15 onto the basket carrier 17.

The upper belt (conveyor belt) 12 includes a novel positioning unit 19, which automatically removes the basket carrier 17 from the upper belt and positions it in the back part of the work surface 21 of the assembly station 3 in an angle of 20° to 45° (at most 15° to 55°) so that the individual components are more easily viewable and extractable. For this purpose, the assembly station 3 has a free surface, which is arranged in front of the lower conveyor belt 13 on which the workpiece carriers 23 are moved, and upon which two rails 25 are mounted, which make it possible to pull a workpiece carrier 23 out from the lower belt to a stop manually and precisely. This position of the workpiece carrier is checked by a sensor and a laser measuring device, which performs the distance measurement for security purposes. Such sensors and laser measuring devices are known as such in conveyor technology and thus not further explained.

Afterward the assembly worker puts the positioning unit which is in initial position into function with both hands via a Dead man's switch, until the process described as example below is completed, by which process the basket carrier 17 is moved from the upper conveyor belt 12 into the tilted position before the upper conveyor 12. The described movements are preferably driven by pneumatic actors.

The gate 27 in the directional control of the upper conveyor belt 12 is opened. The basket carrier 17 placed in front of the opening has two recesses 29 each on both sides (s. FIG. 11). In the first step a first set of pins of a pneumatically driven clamping unit 31 (for opening and closing at the sides of the basket carrier 17) reaches into the recess 29 lying at the front and pulls the basket carrier 17 from the upper conveyor system 12 far enough to forward through the gate 27 to execute the following step. The clamping unit opens, moves to the back of the basket carrier 27, closes again whereby a second set of pins lying further to the front reaches into the recesses 29. The pins, which reaches into the recesses 29 in the first steps now lie behind the basket carrier 17. The clamping unit 31 shifts in the direction of the work surface 21 of the assembly station 3 and turns away into the desired angle (s. FIG. 6). The basket carrier 17 is now positioned and now allowing assembling. The Dead man's switch is let go. After the assembly this same process occurs in reverse to the initial positioning. All steps are respectively monitored by detectors. To reduce shaking caused by the gripping process elastic elements 32 are arranged in the sides of the basket carrier 17, which cushion the impact of the gripping elements of the clamping unit 31.

In the initial position basket carriers 17 and workpiece carriers 23 can pass by on the upper and lower conveyor belts 12, 13 without limitations.

The lower conveyor belt 13 is connected to the central conveyor system 6 of the installation 1 via switches in a way known as such. The central conveyor system 6 is preferably designed in such a way that 20 or more workpieces are moved on it. The complete workpiece carriers 23 are equipped with positioning grooves and sensor plates and additionally comprise a component support plate 33 placed on it with RFID-holder, a clockwork holder 36 in the form of a connector and a manipulation ring 35 for the clockwork. On the support plate 33 there are indentations 34 which are shaped to match the individual components of a clockwork. The indentations 34 are specially designed in such a way, that the component placed within it, especially small and light ones, can only be removed under application of a certain amount of force due to friction, form locking, springs or combinations of these options. This prevents the lifting of the component out of its indentation 34 by adhesion/cohesion forces or surface tension effects during the applying of lubricant. On the other hand, however, these retaining forces must not be too strong, so that the components can be removed for assembly without being damaged, wherefore a meticulous design of the indentations 34 is required.

While loading the upper conveyor belt 12 the basket carriers 17 are guided to the next station with RFID-readers and stopped, so that a specific disassembled clockwork is positioned in the basket 15 on this basket carrier 17 in front of the gate 27. At the same time, the assembly worker lets a workpiece carrier 23 for the clockwork be transported to the next RFID-reader on the lower conveyor belt 13.

The RFID of the workpiece carrier 23 is connected to the RFID of the basket carrier 17 via software in such a way that the further assembly steps on the clockwork are defined and displayed to the assembly worker on a screen (not depicted). The lower conveyor belt 13 has RFID-readers, which transmit the position to the central control before and after the positioning unit for the assembly and at the same time ensures that the matching basket carrier 17 is positioned on the upper belt 12.

After loading of the upper conveyer belt 12 with basket carriers 17 the matching workpiece carriers 23 are individually transported to the assembly station 3 by the conveyor belt 13 and positioned in such a way that the work plate 44 of the clockwork can be mounted on the manipulation ring 35 (s. FIGS. 16-18). The manipulation ring 35 lies on the clockwork holder, a cylindrical connector 36, which is centrally screwed onto the workpiece carrier 23.

By the identification of the order and the related data, it is possible to either work serially or sequentially bit by bit. The related data is respectively displayed on the screen at the workplaces, especially the assembly stations 3. By the automatic oiling in the central oiling unit 9 the assembly of the clockwork is organized differently and much faster than in traditional manual assembly. Components of a clockwork can be placed on the component supporting plate 33, placed on the workpiece carrier 23, in any way, even in unusual positions. Thereby, it is rendered feasible to oil even points that can otherwise only be oiled manually and using both hands.

After every finalized sequential assembly-step the assembly worker sends the completed workpiece carrier 23 either to be oiled (oil unit 9) or to regulation (regulating station 4) on the lower conveyor belt 13. The workpiece carrier 23 is first moved on the lower conveyor belt 12 by a control device, which determines whether everything is assembled and placed correctly. The control is done visually via a camera system. If this is the case the workpiece carrier reaches the central conveyor system 6, otherwise the workpiece carrier 23 is directly returned to the queue before the assembly station 3. As soon as the workpiece carrier 23 reaches the assembly worker the error is displayed on the screen.

The clockwork, which is on the completed workpiece carrier 23, which is going to regulation 4, is wound automatically in the first passage. Via the RFID and the central control, the winding device knows what kind of clockwork it is, which stations it has passed by and how much winding needs to be done.

When a workpiece carrier 23 is in front of the positioning sensor of the winding unit the former stops and stays blocked on the conveyor belt of the setting station. The pneumatic rotation drive 39 swivels the direct current winding motor 41 by 90° from the vertical into the horizontal position according to arrow 93, wherein the rotational axis of the motor is congruent with the rotational axis of the crown 43 of the clockwork 44. The linear motor 45 then moves the direct current winding motor 41 and the winding pliers 47 forward until the stop of the winding pliers 47 impacts on the winding crown 43.

The winding sheath is held fast, while the axis and the winding pliers 47 continue to move forward and thereby cause the closing of the winding pliers. When the inductive sensor is at the correct distance to the firm and movable stop ring, the winding shaft and the winding pliers 47 also stop and the DC winding motor 41 rotates the crown 43 of the clockworks 44 with a rotational speed, which can be varied between 0.5 and 1.5 rotations per second by varying the supply voltage of the winding motor 41.

When the clockwork 44 is fully wound, the winding motor 41 stops and the linear motor 45 reverses all the mentioned steps. It is to be noted that the winding pliers initially opens, but remains in the same position thanks to the effects of a recoil spring. It only begins to draw back when it has fully opened and is free of any contact with crown 43.

The maximum winding moment of the pliers 47 can be regulated via the setting of the position of the inductive sensor. Should the sensor be defective a fixed limit stop prevents a damaging of the winding mechanism of the clockwork 44. This winding unit allows for the automatic winding of mechanical wristwatch clockworks of any size.

Afterwards, the completed workpiece carrier 23 is transported to the regulating station 4, where a regulating worker first inserts the balance-bridge and the shock protectors. The installation is calculated in such a way that the path from the regulating workstation 4 to the oiling 9 is long enough to remove the epilame from the escapement wheel teeth and the anchor pallets before the oiling of the escapement.

When the workpiece carrier 23 arrives at the regulating station 4 for the second time, the amplitude of the oscillation of the escapement and the flatness and centering of the coil spring is checked first and prior to the regulating station and then on a second device, the lost path of the anchor pallet engagement with the escapement wheel is checked. If the amplitude is insufficient and the flatness and centering of the spring coil are insufficient, but the lost path is within tolerance, the clockwork returns to regulating station 4 and is repaired there. The errors are displayed to the regulating worker on the screen at the regulating station 4. If the amplitude is insufficient, but the coil spring is in order, and if the lost path is insufficient, the workpiece carrier 23 with the clockwork 44 goes to a specialist on a special conveyor belt and can then be returned to regulation after repair. By the respective reading of the RFID this event is logged in the central database and the clockwork can be tracked without interruptions.

The amplitude of the escapement-oscillation is measured visually with the first measuring device 49 by taking a large number of pictures over several seconds, so that the amplitude can be determined to an accuracy of 1 (one) degree. At the same time the distances between the windings are measured in two opposite directions. It can hereby be determined whether the coil spring is centered, flat, convex or concave.

The second device 51 measures the lost path visually, by measuring the distance from the lower corner point of the resting surface of the entrance pallet to the rotation point of the anchor (center of the anchor axis) and the distance from the lower corner point of the resting surface of the exit pallet to the rotation point of the anchor. In old escapements these distances need to be of equal size and thus symmetrical. In new escapements on the other hand the distances are constructively different, as for better impulse control, the lifting surfaces of the anchor pallets are positioned at the same distance to the axis between escapement wheel and anchor in the middle of the impulse phase to optimize the isochronism. Thus the distance to the anchor rotation point changes constructively and the median value of a sample of measurements of equal anchors can be assumed as a reference value which should be determined visually. If the measured value of an anchor lies within a tolerance of +/−three microns (micrometers) from the reference value, its function is good. If the measured value lies far outside the range of tolerance the anchor must be repaired.

After the pre-check the regulating worker checks the daily deviation in motion via motion checking devices 53, the number of which can be between 2 and 10 devices, and if necessary, immediately performs the regulation. It is ensured via a parking space system for the workpiece carriers and outfitted with sensors that no mix-ups can occur. If the clockwork is adjusted within the necessary tolerance, the completed workpiece carrier 23 either goes to the oiling 9 or directly to the assembly 3, depending on the clockwork model.

On the central conveyor system 6 of the installation there are RFID-readers, switches and diverters known as such. The interaction of this infrastructure in connection with the central control ensures that the respective workpiece carriers 23 find their way to and from the correct place, depending on the task each time.

The oil station 9 is the central setup of the installation 1. To position the completed workpiece carriers 23 on the oil station 9 and to also unload them again, a handling robot 55 is deployed, which positions them in a predetermined holder (s. FIG. 7 ff.) on one or several rotary plates 57 rotating in only one direction. The rotary plate 57 is designed in such a way that in addition to one or several positioning holders 59 for workpiece carriers 23 there is also one turning unit 61 per workpiece carrier 23. The handling robot 55 has a gripper 63 by which the handling robot 55 can remove the manipulation ring 35 with clockwork from the completed workpiece carrier 23 and position it on the turning unit 61. This turning unit 61 guarantees the ideal positioning of the clockwork in all axes and can rotate the clockwork by 180° if required, so that the backside is accessible. It additionally serves the oil robot 65 for precise oiling.

The exact positions of the components of the clockwork which are in the indentations 34 intended for this on the support plate 33 attached to the workpiece carrier are measured and identified by the 3D-laserscanner, which is mounted on the robot oil head 69, in connection with measuring sensors. These values are processed by the control unit of the oil robot and guide the respective oil nozzle 81 precisely to the oiling point or—for example in shock protectors—directly into the hole of the clock jewel.

A robot oil head 69 is installed on the oil robot 65. It is equipped with distance sensors, 3D-laserscanner, camera, light source and oil dosing heads, on which there are different types of nozzles, respectively adapted for the viscosity of the oil or fat. Exemplarily there are six oil dosing heads 71, one laser profile scanner 73 for determining the height in z-direction (vertical to the surface of the support plate 33), a centrally arranged camera 75 with light 79 arranged around the lens in circular shape in FIG. 10. A line laser 80 serves for the focusing of the camera 75. To set a zero point for the height (z-axis) a reference pin can be provided at the oil dosing head.

The nozzles 81 of the oil dosing heads 71 can have different shapes, be it straight with one hole, bent or with a side opening. The oil dosing head can, depending on the oil point, also be used tilted. Once oiling is finished, the result is checked via camera 75 to ensure that all oil points have been lubricated.

The oil dosing heads 71 respectively serve the application of a lubricant to specific points. An oil dosing head 71 has a lubricant reservoir 87. The lubricant in the reservoir 87 gets to the nozzle 81 through the dosing valve 89. Preferably the robot oil head 69 can be rotated around a rotational axis through the camera 75 in order to move an oil dosing head 71 into an optimal working position.

Instead of a lubricant an oil dosing head 71 can also contain an epilame. Particularly, it is thereby also possible to apply an epilame and to quickly let the epilame evaporate or dry. Afterward, it is possible to oil within the delicate area, protected by the epilame, and the epilame prevents that the lubricant diffuses or spreads into areas where a lubricant is not wanted.

For oiling the escapement, the clockwork needs to be stopped. During the traditional oiling, it is done by hand. But via the manipulation ring 35 and an automatically controlled device which consists of almost the same components as the winding station (winding unit) 37, the extraction and insertion of the crown 43 of the clockwork occurs automatically during oiling. Thereby, the crown is brought into the predetermined position by the device according to the respective clockwork specifications by horizontal extraction. Because of the thus activated stop-second, the clockwork stands still. Then the escapement wheel is oiled, the crown is pushed in, the clockwork is left to run for some tenths of seconds, the crown is extracted again and the escapement wheel is oiled again. This process is repeated several times to ensure a good distribution of the oil on the displacement wheel and the anchor pallets.

The oil robot needs to switch to the nozzle cleaning and checking station 85 at predetermined intervals. At that station, the nozzles 81 are submerged into epilame, the nozzles cleaned on a cloth and by rotating brushes. Afterward, several test oil dots are put onto a test field to test the functionality.

In view of the required precision of the movements particularly of the robots of the oil unit 9, the installation is operated in an environment of constant temperature.

The workpiece carriers are driven into a protected position when they are not in use or the installation is turned off, so to avoid dust depositions etc.

Details Winding Unit (s. FIGS. 23-25)

When the workpiece carrier 23 arrives in front of the positioning sensors (not depicted) (FIG. 24), the pneumatic rotation drive 39 rotates the motor carrying arm 91 and the DC motor (direct current motor) 41 by 90° according to arrow 93. The winding pliers 47 are then in the same axis as the crown 43 of the clockwork. Now, the linear step motor (linear motor) 45 can move the winding pliers 47 toward the crown 43.

When the crown 43 touches the inner stop 95 of the winding pliers 47 the collet 97 closes on the crown 43 through the combined effect of the cones 98 and 99, which are arranged on the winding pliers 47 and the collet 97 respectively.

When the end of the inductive end position sensor 101 is in a defined distance from the winding ring 103, which is firmly connected to the inner stop 95, the linear motor 45 stops and the DC winding motor 41 activates itself to begin the winding sequence for the crown of the clockwork (roughly 40 rotations at a speed of 1 to 1.5 rotations per second).

When the winding sequence of the crown 43 of the clockwork is finished, the DC motor 41, which is controlled by the computer system, stops and the linear motor 45 moves the winding pliers 47 away from the crown 43. Initially the inner stop 95 and the collet 97 remain in contact with the crown 43 through the effects of the recoil spring 105, while the cone 98 and 99 separate from each other and the collet 97 opens. As soon as the collet 97 is open, the winding pliers 47 and the collet return to the initial position together, which is defined by the control of the linear motor 45. It stops and the pneumatic rotation drive 39 rotates the motor carrying arm 91 with DC motor 41 back by 90° to return the winding unit 37 into its initial position.

The workpiece carrier 23 can then proceed on its path, while the next workpiece carrier 23 arrives in front of the (non-depicted) positioning sensors.

### Further Advantages and Features of the Exemplary Embodiment

The presented installation meets the following requirements, among others:
Assembling and regulating a clockwork within the framework of a repair and ensuring therein during repair that all components present within a clock which do not need to be exchanged, are assembled back into the same clockwork.
Clockworks of different types can be serially assembled at the same time, especially via the usage of support plates, which are respectively exactly fitted to the caliber (particularly the outer dimensions of the components) of a clockwork and via manipulation rings, the inner openings of which are respectively precisely fitted to the caliber, but can be placed on a uniform carrier (connector 36).
Modular installation with central oil station for the assembly and repair of clockworks which allows for the serial assembling of different clockwork builds at the same time and therein ensures in the usage during repair that all components present within a clock which do not need to be exchanged are assembled into the same clockwork again.
An uninterrupted tracking of the clockworks and their components in that the installation is provided with a central programmed control unit and all workpiece carriers and basket carriers are marked by an RFID, so that it is possible to determine at any time where those carriers are located, which works have already been executed and where they have to go next, and in that reading units are positioned at all entries and exits, in front of all switches of the conveyor system, at the working stations, before and after the assembly, as well as at the motion checking at the regulating place. The installation program detects which basket carriers belongs to which workpiece carrier and positions the first accordingly. It also reveals within which timespan which station assembles, where bottlenecks may occur, and controls the individual devices of the installation. At the same time, it feeds the displays at the workplaces with clockwork-specific information regarding the assembly or regulation and with information about the error evaluation obtained by the control devices.
An automated oil unit in form of an oil robot which has a robot head to which several oil dosing heads with different lubricants and different nozzles are attached which make it possible to lubricate and oil a clockwork and the components on a workpiece support plate as well as the escapement thanks to an automated appliance for the pulling and pushing of the crown with the required precision.
Controlling of the oil robot by the central control, so that different clockworks can be oiled sequentially and without re-adjustment.
Optimal provision of baskets and workpiece carriers with the correct support plate and matching manipulation ring: An assembly station is equipped with two independent conveyor systems. The upper, elevated conveyor system for the basket carrier is additionally equipped with a positioning unit. The positioning unit automatically detects, via laser measurement and sensors, if and that the workpiece carrier was manually moved to the stop in front of the assembly worker from the lower belt. Afterwards, the positioning unit is triggered using both hands via a dead man's switch and the basket carrier is positioned in front of the assembly worker in a desired tilted position behind the workpiece carrier by a piston and valve system with multiple axes. The removal and the visual detection of the components is thus simplified significantly.
Suitable arrangement of the components of a clock for an automated assembly, especially including lubrication: the workpiece carrier on the lower conveyor system of the assembly station has a clockwork specific support plate placed on it, within which the components of the clockwork can be precisely positioned in designated receptacles by the assembly worker depending on the point that is to be oiled, so that they are oiled automatically. There is also centrally a pipelike work holder, on which an assembly ring, with the assembly rings having the same outer diameter, can be snapped on, each assembly ring having four precise notches on the outer side. The base plate (work plate) of an arbitrary clockwork is mounted in the assembly ring using the screws required for the encasing of the base plate in the clock casing, which guarantees the exact positioning of the clockwork for the automatic oiling and the clockwork can be turned automatically via a gripper during the oiling.
Reliable, automated control of the processing condition of the clockworks: On the lower conveyor system, a visual control device is installed downstream of the assembly station. The visual control device photographs clockwork and support plate at the same time and checks using artificial intelligence, whether all components are put in the correct places and show no signs of damages.
Checking of spiral and balance-wheel: Via a large number of recordings per second it is determined whether the amplitude of the balance-wheel attains the demanded minimum-degree value. At the same time a device determines, thanks to the different visual distance measurements of the spiral windings, whether the spiral is faulty (for example decentered, not flat, concave, convex). If such an error occurs it is reported to the control and displayed to the regulator simultaneously with the arrival of the clockwork at the work station.
Checking of the lost path: At the regulating station, a visual measuring device is present for checking the lost path. It determines the distance of the anchor pallets (lower lifting surface corner) to the center of the anchor axis via optical distance measurements. If this distance significantly diverges from the prescribed tolerance (e.g. +/−0.003 mm), the anchor plates have been displaced in a previous repair process and must be realigned by a specialist. Such clockworks are automatically guided to a storage space for faulty clockworks via the central conveyor belt.

From the preceding description, the one skilled in the art is able to conceive additions and variations without leaving the scope of protection of the invention, which is defined by the attached claims. For example, it is conceivable:
The rotary plates 57 are designed to rotate in two directions.
The oil station is equipped with one oil robot instead of two.
There is more than one oil station.
The number of the oil dosing heads can be selected differently depending on the design of the robot oil head, e.g. in the range from one to ten. Other conceivable numbers are 3, 4, 5, 7, 8, 9, without thereby excluding a non-stated number. Principally, the number of oil dosing heads is conditioned by the spatial requirements of the oil pints (type of nozzle) and the amount of different lubricants.

List of Reference Numerals

| | |
|---|---|
| 1 | modular installation |
| 3 | assembly station |
| 4 | regulating station |
| 7 | local conveyor systems |
| 9 | oil unit |
| 12 | upper conveyor belt |
| 13 | lower conveyor belt |
| 15 | cleaning basket / basket |
| 16 | compartment in cleaning basket |
| | for clockwork |
| 17 | basket carrier |
| 18 | protrusion on 16 for actuating |
| | shaft with crown |
| 19 | positioning Unit |
| 21 | work surface (assembly station) |
| 23 | workpiece carrier |
| 25 | rail |
| 27 | gate |
| 29 | recesses |
| 31 | clamping unit |
| 32 | puffer element |
| 33 | component support plate |
| 34 | indentation (reception of |
| | component) |
| 35 | manipulation ring |
| 36 | connector |
| 37 | winding unit |
| 39 | pneumatic rotation drive |
| 41 | direct current winding motor |
| 42 | actuating shaft |
| 43 | crown (of clockwork) |
| 44 | working plate |
| 45 | linear motor |
| 47 | winding pliers |
| 49 | 1st measuring device: amplitude, |
| | spiral |
| 51 | 2nd measuring device |
| 53 | motion checking device |
| 55 | handling robot |
| 57 | rotary plate |
| 59 | positioning holder |
| 61 | turning unit |
| 63 | gripper |
| 65 | oil robot |
| 69 | oil robot head |
| 71 | oil dosing head |
| 73 | laser profile scanner |
| 75 | camera |
| 77 | lens |
| 79 | ring light around 77 |
| 80 | line laser |
| 81 | nozzles |
| 85 | nozzle cleaning and checking |
| | station |
| 87 | lubricant reservoir |
| 89 | dosing valve |
| 91 | motor carrying arm |
| 93 | arrow: movement |
| 95 | inner stop |
| 97 | collet |
| 98 | cone |
| 99 | cone |
| 101 | inductive end position sensor |
| 103 | winding ring |
| 105 | recoil spring |

1. A modular installation for the assembly and repair of clockworks, comprising; characterized in
at least one central oil station for oiling parts of a clockwork,
at least one assembly station with a staying place, preferably a seat, for one person,
the central oil station being equipped with at least one robot for a fully automatic function, so that all required oil points of a clockwork or components of the clockwork can be lubricated in the oil station; and
a central conveyor system that connects the assembly stations and the central oil stations to one another and preferably has a branch so that defective clockworks can be sorted out, in order to be able to assemble clockworks of different types in series and oil them automatically at the same time.

2. The modular installation according to claim 1, wherein a workpiece carrier is designed to receive the clockwork and the components removed from the clockwork for machining and to be reinserted into the clockwork, preferably with sockets adapted to the components in each case, so that it is ensured that all parts of a clockwork are reinserted when there are no more components on the workpiece carrier and that preferably the individual parts in the adapted sockets can be provided with a lubricant.

3. The modular installation according to claim 2, wherein at least one socket for a component of a clockwork is designed such that the component is held with such a force by at least one of friction, form locking and the action of a spring that a lubricant can be applied to the component in the socket without the component being removable from the socket by the lubricant.

4. The modular installation according to claim 1, wherein at the assembly station:
a first, elevated conveyor system is present in the center of the assembly station for the transport of basket carriers, which are designed to transport a cleaning basket each for components of one respective clockwork, and
a second, lower arranged conveyor system is present for workpiece carriers which are designed for at least partially ordered reception of the components of a respective clockwork,
wherein the lower arranged conveyor system is arranged on the outside relative to the elevated inner conveyor system, so that the outer conveyor system is located between the staying place and the elevated conveyor system,
the elevated conveyor system is equipped with a first positioning unit for the basket carriers,
the first positioning unit is set up that a basket carrier can be moved out of the elevated conveyor system towards the staying place and can be pivoted through an angle, preferably in the range of 15° to 55°, further preferably 20° to 45°, to facilitate an access to parts in a cleaning basket on the basket carrier and a visual inspection of the clockwork components in the cleaning basket on the basket carrier.

5. The modular installation according to claim 4, wherein the positioning unit for the assembly is provided with a control unit for controlling the clockwork and workpiece carrier after assembly and the control unit is set up to determine that all parts per work step are correctly mounted in the clockwork or positioned on the support plate as previously determined.

6. The modular installation according to claim 1, further comprising a central programmed controller unit and all workpiece carriers and basket carriers are each provided with an RFID marking and reading units for the RFID markings are present at all inlets, outlets and switch points of the conveyor systems and at the conveyor systems at the inlet to and at the outlet from the work stations, such as the assembly stations, so that it can be determined by the controller unit where a workpiece carrier or a basket carrier is located, which work has already been carried out on a set of components being moved with a carrier and where the workpiece carrier or basket carrier needs to be moved to.

7. The modular installation according to claim 1, further comprising at least one regulating station, preferably with at least one of the following devices:
a) an automatic winding unit
a pre-control device for the amplitude of the oscillation of a balance-wheel, and
c) a control unit for the lost path of the escapement of a clockwork.

8. The modular installation according to claim 1, wherein at least one of the at least one central oil station comprises:
at least one clockwork turning unit, preferably at least two, equipped for turning a clockwork held in the clockwork turning unit, so that optionally the front side or the back side of the clockwork is accessible from above by turning it, wherein the clockwork turning unit is preferably arranged on a rotary plate;
an at least 3-axis oil robot with a special robot oil head, which comprises at least one oil dosing unit, preferably at least three, four or six with increasing preference, wherein each oil dosing unit is set up to apply a lubricant, so that a lubricant per oil unit can be applied to oil points on the clockwork and components in a specific manner each time,
a handling device set up for positioning one of the workpiece carriers and for positioning a clockwork on the clockwork turning unit;
so that a clockwork, preferably additionally other parts of a clockwork, can be provided with a predetermined lubricant at precisely predetermined points.

9. The modular installation according to claim 8, wherein the oil station comprises a rotary plate on which
at least one clockwork turning unit, preferably at least two clockwork turning units, is arranged and
at least one workpiece carrier holder, preferably a number of workpiece carrier holders equal to the number of clockwork turning units on the rotary plate, are arranged, in order to grip at least one workpiece carrier carrying parts of a clockwork, preferably more than one such workpiece carrier simultaneously, and to render it available to the oil robot.

10. The modular installation according to claim 8, wherein the oil robot is designed to be positioned relative to a workpiece with a deviation of at most 0.05 mm, preferably of at most 0.02 mm and further preferably of at most 0.01 mm.

11. The modular installation according to claim 1, wherein the workpiece carrier is provided with a manipulation ring receptacle for a manipulation ring and at least one manipulation ring is present, the circumference of which is adapted to the manipulation ring receptacle, so that the manipulation ring is held in the manipulation ring receptacle, and each manipulation ring has a receptacle for a clockwork of a predetermined caliber, so that clockworks of different calibers can be inserted into the manipulation ring receptacle and can be manipulated by a gripping instrument, which is designed for the circumference of the at least one manipulation ring, preferably with a positional inaccuracy of at most 0.05 mm, more preferably of at most 0.02 mm and still more preferably of at most 0.01 mm.

12. The modular installation according to claim 1, wherein a winding unit is present in a working area of the oil robot, which is set up to pull out and push in the crown of a clockwork in order to bring the crown into the winding state and to set it into a state of standstill of the clockwork, and to carry out a winding process in such a way that the escapement of the clockwork can be set into various positions and in these positions lubricant can be provided by the oil robot at points which are only accessible for lubrication in certain states of the escapement.

13. The modular installation according to claim 1, wherein the automatic winding unit is equipped with a pivoting arm and a winding pliers in order to grip the crown of a clockwork, to hold it and to wind it up to the desired full winding according to the information in the RFID marking, wherein the winding speed can be varied.

14. The modular installation according to claim 1, wherein the oil robot has a nozzle cleaning system, preferably with a device for test oiling, so that the oil robot can clean itself and preferably can carry out a test oiling in order to ensure and preferably check the positioning precision and the volumetric precision of the lubricant dispensing.

15. The modular installation according to claim 7, wherein the regulating station comprises a visual amplitude measuring device which is designed to record optical recordings of a balance-wheel and of a balance spring of a clockwork coupled to the balance-wheel at a rate per second, which is at least 2 times, preferably at least 4 times and more preferably at least 8 times the nominal oscillation frequency of the balance-wheel, so that the amplitude of the oscillation of the balance-wheel can be determined from the recordings and the state of the balance spring can be determined from the recordings of the balance spring.

16. The modular installation according to claim 1, wherein a winding unit is present, which has a pliers unit attached to a winding motor, and that the pliers unit is attached to a pivoting unit, so that the axis of rotation of the pliers unit can be aligned with the axis of rotation of a crown on a workpiece carrier, and in that the pliers unit is designed to be brought into mechanical connection with the crown by being pushed onto the crown, so that the crown can be set into a rotational movement by the winding motor via the pliers unit and the clockwork can be wound.
